(19) United States
(12) Patent Application Publication
(10) Pub. No.: US 2019/0311851 A1
(43) Pub. Date: Oct. 10, 2019

(54) METHOD OF PRODUCING ND-FE-B MAGNET

(71) Applicant: TOYOTA JIDOSHA KABUSHIKI KAISHA, Toyota-shi (JP)

(72) Inventors: Kazuaki HAGA, Toyota-shi (JP); Daisuke ICHIGOZAKI, Toyota-shi (JP)

(73) Assignee: TOYOTA JIDOSHA KABUSHIKI KAISHA, Toyota-shi (JP)

(21) Appl. No.: 16/359,507

(22) Filed: Mar. 20, 2019

(30) Foreign Application Priority Data
Apr. 5, 2018 (JP) 2018-073494

(51) Int. Cl. H01F 41/02; H01F 1/08; H01F 1/057; B22F 3/14

(52) U.S. Cl. CPC H01F 41/0253; B22F 3/14; H01F 1/057; H01F 1/086

(57) ABSTRACT

The present disclosure provides a technology of further improving magnetic properties (such as residual magnetic flux density) of Nd—Fe—B magnets. The method of producing an Nd—Fe—B magnet of the present disclosure comprises: producing a sintered body having a structure comprising a main phase and a grain boundary phase and having an Nd—Fe—B magnet composition in which Tw/(Rw×Bw) is 2.26 to 2.50, wherein Rw represents a total percent (%) by weight of rare-earth elements and elements other than Fe, Ni, Co, B, N, and C, Tw represents a total percent (%) by weight of Fe, Ni, and Co, and Bw represents a total percent (%) by weight of B, N, and C; and heat treating the sintered body in a low temperature range of 580° C. to 640° C. and a high temperature range of 660° C. or more.

### CROSS REFERENCE TO RELATED APPLICATIONS

The present application claims priority from Japanese patent application JP 2018-073494 filed on Apr. 5, 2018, the content of which is hereby incorporated by reference into this application.

### BACKGROUND

### Technical Field

The present disclosure relates to a method of producing a rare-earth magnet.

### Background Art

Rare-earth magnets such as Nd—Fe—B magnets are also called permanent magnets, which are used for hard disks, motors for MRI systems, and motors for driving hybrid vehicles, electric vehicles, and the like.

JP 2016-96203 A teaches that hot-deformed magnets are produced by a method comprising solidifying a melt of an RE-Fe—B alloy (RE is a rare-earth element) by quenching and pressurizing an amorphous or fine crystalline solid material at a high temperature for setting the orientation of crystals, and such production method is called a hot deformation processing method. JP 2016-96203 A further teaches that it cannot be said that there has been progress in the practical use of hot-deformed magnets because it is difficult to achieve high crystalline orientation since crystalline orientation is set by utilizing crystal rotation and crystal anisotropic growth, which result in poor magnetic properties. JP 2016-96203 A also discloses a method of improving coercive force of a hot-deformed magnet, comprising quenching a melt of an RE-Fe—B alloy (RE is a rare-earth element) to obtain an amorphous starting material powder or a compact thereof and rapidly heating the powder or compact at a temperate rising rate of 400° C./minute or more to a temperature not less than the crystallization initiation temperature, for example, 600° C. to 800° C.

### SUMMARY

The present disclosure provides a technology of further improving magnetic properties (such as residual magnetic flux density) of Nd—Fe—B magnets.

The method of producing an Nd—Fe—B magnet of the present disclosure comprises:

producing a sintered body having a structure comprising a main phase and a grain boundary phase and having an Nd—Fe—B magnet composition in which Tw/(Rw×Bw) is 2.26 to 2.50, wherein Rw represents a total percent (%) by weight of rare-earth elements and elements other than Fe, Ni, Co, B, N, and C,

Tw represents a total percent (%) by weight of Fe, Ni, and Co, and

Bw represents a total percent (%) by weight of B, N, and C; and

heat treating the sintered body in a low temperature range of 580° C. to 640° C. and a high temperature range of 660° C. or more.

According to the method of producing an Nd—Fe—B magnet of the present disclosure, magnetic properties of Nd—Fe—B magnets can be improved.

The method of producing an Nd—Fe—B magnet of the present disclosure further comprises subjecting the sintered body to hot deformation processing after the production of the sintered body and before the heat treatment in some embodiments.

According to the method of producing an Nd—Fe—B magnet of the present disclosure, magnetic properties of an Nd—Fe—B magnet can be improved.

### BRIEF DESCRIPTION OF THE DRAWINGS

FIG. 1 is a diagram of a heating path for heat treatment which is conducted after hot deformation processing of a sintered body including an Nd—Fe—B magnet in the Examples.

FIG. 2 is a diagram of the relationship between the composition ratio (Tw/Rw/Bw) of an Nd—Fe—B magnet composition and the presence or absence of the residual magnetic flux density increasing effect.

FIGS. 3a and 3b are schematic diagrams explaining the sintered body production in the method of producing an Nd—Fe—B magnet according to the present disclosure in the order of (a) and (b), and FIG. 3c is a schematic diagram explaining the hot deformation processing.

FIG. 4a is a diagram explaining the microstructure of the sintered body illustrated in FIG. 3b, and FIG. 4b is a diagram explaining the microstructure of the sintered body (magnet precursor) after the hot deformation processing illustrated in FIG. 3c.

### DETAILED DESCRIPTION

Hereinafter, embodiments of a coolant composition according to the present disclosure will be specifically described. The present disclosure is not limited to the embodiments described below.

<1. Nd—Fe—B Magnet Composition>

A starting material composition used in the present disclosure is an Nd—Fe—B magnet composition in which Tw/(Rw×Bw) (also expressed as “Tw/Rw/Bw”) is 2.26 to 2.50. Surprisingly, when a sintered body having such an Nd—Fe—B magnet composition is subjected to the heat treatment described later, an Nd—Fe—B magnet having excellent magnetic properties and specifically an Nd—Fe—B magnet having a high residual magnetic flux density can be produced.

Rw represents a total percent (%) by weight of rare-earth elements and elements other than Fe, Ni, Co, B, N, and C with respect to a total amount of starting material elements. Examples of the “elements other than Fe, Ni, Co, B, N, and C” used herein include at least one selected from Ti, Ga, Zn, Si, Al, Nb, Zr, Mn, V, W, Ta, Ge, Cu, Cr, Hf, Mo, P, Mg, Hg, Ag, and Au. In a case in which a starting material does not include “elements other than Fe, Ni, Co, B, N, and C,” Rw represents a total percent (%) by weight of rare-earth elements with respect to a total amount of starting material elements. In a case in which a starting material includes “elements other than Fe, Ni, Co, B, N, and C,” Rw represents a total percent (%) by weight of rare-earth elements and “elements other than Fe, Ni, Co, B, N, and C” with respect to a total amount of starting material elements. Only one rare-earth element such as Nd may be used, or two or more rare-earth elements may be used. Y (yttrium) is also included the rare earth elements. Starting material elements include at least Nd and may further include at least one additional rare-earth element in other embodiments.

Tw represents a total percent (%) by weight of Fe, Ni, and Co with respect to a total amount of starting material elements. Fe, Ni, and Co are transition metal elements. Starting material elements may include at least one of Fe, Ni, and Co as transition metal elements, and in other embodiments, starting material elements include at least Fe and may further include at least one of Ni and Co. For example, in a case in which starting material elements include Fe exclusively as a transition metal element, Tw represents a total percent (%) by weight of Fe with respect to a total amount of starting material elements. In a case in which starting material elements include Fe and Ni exclusively as transition metal elements, Tw represents a total percent (%) by weight of Fe and Ni with respect to a total amount of starting material elements.

Bw represents a total percent (%) by weight of B, N, and C with respect to a total amount of starting material elements. B, N, and C are light elements. Starting material elements may include at least one of B, N, and C as light elements, and in other embodiments, starting material elements include at least B and may further include at least one of N and C. For example, in a case in which starting material elements include B exclusively as a light element, Bw represents a total percent (%) by weight of B with respect to a total amount of starting material elements. In a case in which starting material elements include B and N exclusively as transition metal elements, Bw represents a total percent (%) by weight of B and N with respect to a total amount of starting material elements.

The Nd—Fe—B magnet composition is not particularly limited as long as it has the above-described features. However, one example thereof is expressed by the following composition formula: RₐTM_{b}B_{c}M1_{d}M2ₑ (R represents at least one rare-earth element, TM represents at least one of Fe, Ni, and Co, B represents boron, M1 represents at least one of Ti, Ga, Zn, Si, Al, Nb, Zr, Mn, V, W, Ta, Ge, Cu, Cr, Hf, Mo, P, Mg, Hg, Ag, and Au, M2 represents at least one of N and C, 12≤a≤20, b=100-a-c-d-e, 5≤c≤20, 0≤d≤3, 0≤e≤3 (at %)).

R includes at least Nd in some embodiments.

TM includes at least Fe in some embodiments.

d satisfies 0≤d≤1.5 in some embodiments.

e satisfies 0≤e≤1 in some embodiments.

<2. Production of Sintered Body>

Typically, the production of the sintered body includes quenching a molten metal having an Nd—Fe—B magnet composition with the above features to form a melt-spun ribbon having a structure including nanocrystals (nanocrystalline structure) and sintering the obtained melt-spun ribbon or a pulverized product of the melt-spun ribbon.

The nanocrystal structure mentioned herein is a polycrystalline structure in which crystal grains are nano-sized. The “nano size” mentioned herein is equal to or less than the size of a single magnetic domain, and it is, for example, about 10 nm to 300 nm.

The rate of quenching is in a range suitable for the solidified structure to become a nanocrystalline structure.

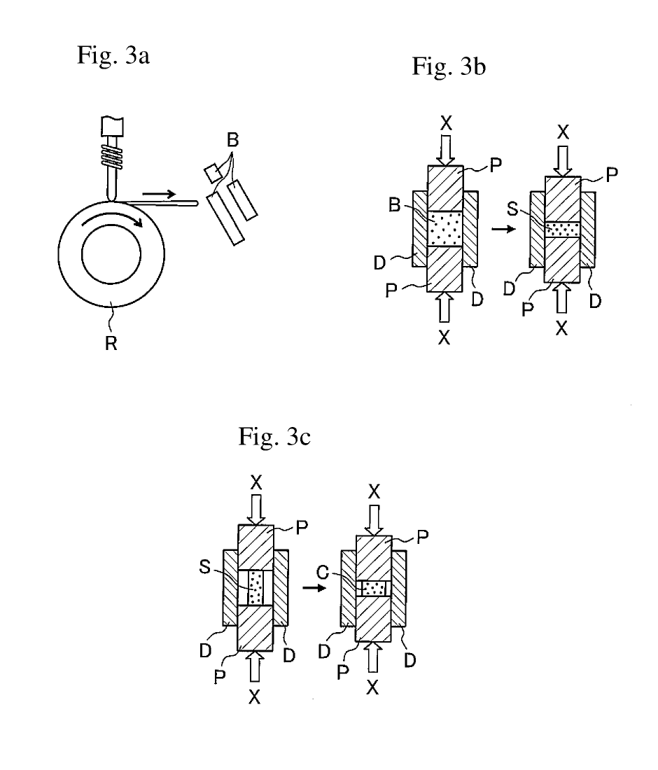

The quenching method is not particularly limited. However, typically, as illustrated in FIG. 3a, for example, an alloy ingot is melted by high-frequency induction heating in an Ar gas atmosphere depressurized to 50 kPa or less in a furnace (not shown) by a single role melt spinning method, and a molten metal with a composition that will provide an Nd—Fe—B magnet is sprayed at a copper role R, thereby producing a melt-spun ribbon B. The produced melt-spun ribbon B is coarsely pulverized as required.

The above method of sintering a melt-spun ribbon having a nanocrystalline structure or a pulverized product thereof is not particularly limited. However, sintering is conducted at a temperature as low as possible in a short time so as not to cause the nanocrystalline structure to be coarsened. Therefore, sintering is conducted under pressurization in some embodiments. In a case in which sintering is conducted under pressurization, a sintering reaction is promoted, thereby making it possible to achieve low temperature sintering and maintain the nanocrystalline structure.

It is also desirable that the rate of temperature rising to the sintering temperature is as fast as possible so that the crystal grains of the sintered structure are not coarsened.

From these viewpoints, it is desirable to perform sintering by energization heating along with pressurization, which is, for example, so-called “spark plasma sintering (SPS).” Accordingly, the sintering temperature can be decreased by promoting energization through pressurization, and the temperature can be increased to the sintering temperature in a short time, which are advantageous in maintaining the nanocrystalline structure.

Note that sintering is not limited to SPS, and hot pressing may be employed.

Further, as one type of sintering method by hot pressing, a method using an ordinary press molding machine or the like in which high-frequency heating and heating by an attached heater are combined is also suitable. In high-frequency heating, a workpiece is directly heated using an insulating die/punch, or a conductive die/punch is heated so as to indirectly heat a workpiece by the heated die/punch. For heating by an attached heater, a die/punch is heated by a cartridge heater, a band heater, or the like.

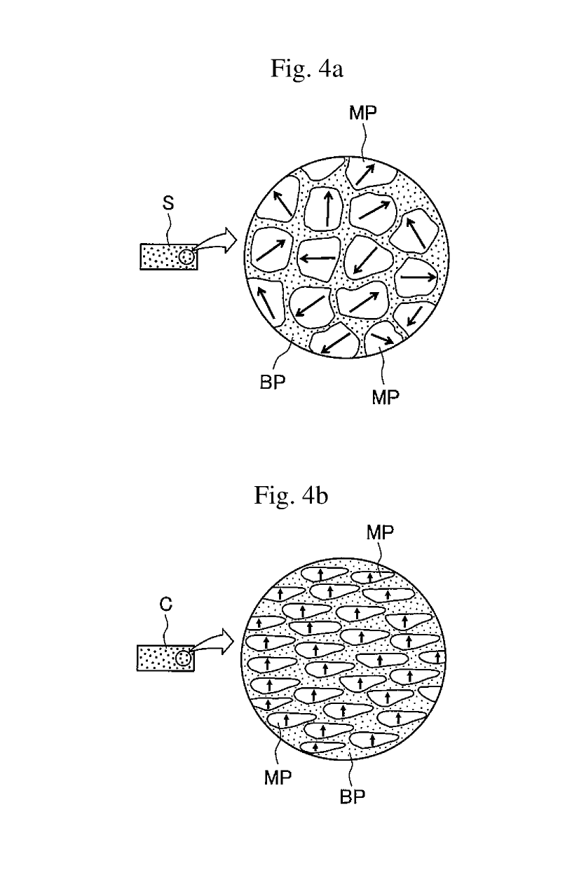

One example of a sintering method by energization heating along with pressurization is described with reference to FIG. 3b. FIG. 3b illustrates an example of production of a sintered body S having a structure comprising a main phase and a grain boundary phase by filling a roughly pulverized melt-spun ribbon B in a cavity defined by a carbide die D and a carbide punch P that slides inside the cavity and applying a current during pressurization by the carbide punch P in the pressurization direction (X direction) for energization heating so as to sinter the pulverized product. As illustrated in FIG. 4a, the obtained sintered body S has an isotropic crystal structure in which each nanocrystal grain (MP: main phase) is surrounded by a grain boundary phase (BP).

<3. Hot Deformation Processing>

The sintered body obtained in the sintered body production step can be subjected to the heat treatment described later. However, before the heat treatment, the sintered body may be subjected to hot deformation processing (such as rolling, forging, or extrusion processing) in some embodiments.

Hot deformation processing involves hard machining, for which a rate of work that corresponds to a degree of deformation of a sintered body in terms of thickness is 30% or more, 40% or more, 50% or more, 60% or more, or 60% to 80% in some embodiments.

As a result of hot deformation of a sintered body, crystal grains themselves and/or the crystal direction of crystal grains rotate along with sliding deformation, and the easy axis of magnetization (c axis in the case of a hexagonal crystal) becomes oriented (anisotropic). Once a sintered body has a nanocrystalline structure, it allows crystal grains themselves and/or the crystal orientation of crystal grains to easily rotate, thereby promoting orientation. Accordingly, a fine texture in which nano-sized crystal grains are highly oriented is realized, and an anisotropic magnet having a remarkably improved residual magnetic flux density while securing high coercive force can be obtained. In addition, favorable squareness can also be realized by a homogeneous crystal structure composed of nano-sized crystal grains.

FIG. 3c illustrates a step of conducting hot deformation processing in a state in which a carbide punch P is brought into contact with an end face of a sintered body S in the longitudinal direction (the horizontal direction is the longitudinal direction in FIG. 3b) such that the carbide punch P pressurizes the sintered body S in the X direction, thereby imparting magnetic anisotropy to the sintered body S. As a result of this step, a sintered body (magnet precursor) C subjected to hot deformation processing, which has a crystal structure comprising anisotropic nanocrystal grains (MPs), is produced as illustrated in FIG. 4b.

<4. Heat Treatment>

The heat treatment is a step of subjecting the sintered body obtained in the sintered body production to a heat treatment in a low temperature range of 580° C. to 640° C. and a heat treatment in a high temperature range of 660° C. or more. Before the heat treatment, the sintered body may be subjected to hot deformation processing as required.

The order of heat treatment in a low temperature range of 580° C. to 640° C. and heat treatment in a high temperature range of 660° C. or more is not particularly limited, and therefore, either of them may be conducted first.

For heat treatment in a low temperature range of 580° C. to 640° C. and heat treatment in a high temperature range of 660° C. or more, the retention time in each temperature range may be 1 minute or more, 3 minutes or more, 5 minutes or more, 10 minutes or more, 15 minutes or more, or 20 minutes or more while it may be 5 hours or less, 3 hours or less, 1 hour or less, or 45 minutes or less.

The low temperature range is 590° C. to 640° C., 600° C. to 640° C., 610° C. to 640° C., or 615° C. to 635° C. in some other embodiments.

The high temperature range is 665° C. or more or 670° C. or more while it is 800° C. or less, 750° C. or less, 700° C. or less, 690° C. or less, 685° C. or less, or 680° C. or less in some other embodiments.

A mechanism, by which an Nd—Fe—B magnet having excellent magnetic properties can be obtained by subjecting the sintered body to two-stage heat treatment in the low temperature range and the high temperature range, is not particularly limited. However, the following mechanism can be assumed.

In a sintered body having a main phase and a grain boundary phase comprising an Nd—Fe—B magnet composition before the heat treatment, the main phase mainly contains an Nd₂Fe₁₄B phase (T₁ phase), and the grain boundary phase contains an Nd—Fe phase, in addition to an Nd phase. It is assumed that the Nd—Fe phase is formed as a result of dissolution of a part of the T₁ phase in the grain boundary phase. The presence of the Nd—Fe phase is considered to cause deterioration of magnetic properties of a magnet.

In the Nd₂Fe₁₄B phase, Nd may be at least partially substituted by a different rare-earth element, Fe may be at least partially substituted by a different transition metal element (typically Ni or Co), B may be at least partially substituted by a different light element (typically N or C). The Nd phase may contain other elements such as the elements mentioned in M1 above, in addition to Nd. The Nd—Fe phase may contain a compound comprising Nd and Fe (e.g., Nd₅Fe₁₇ or Nd₂Fe₁₇) or a compound other than Nd₂Fe₁₄B, which includes Nd, Fe, and B (e.g., NdFeB₄).

Heat treatment in the low temperature range allows the coating by the grain boundary phase on the surface of the main phase to be homogenized. In particular, in a case in which a sintered body is subjected to hot deformation processing, distortion (inducing deterioration of magnetic characteristics) occurs on the surface of the main phase. However, heat treatment in the low temperature range is assumed to have an effect of correcting distortion on the surface of the main phase.

Meanwhile, heat treatment in the high temperature range is assumed to have an effect of converting the Nd—Fe phase in the grain boundary phase to the T₁ phase so as to allow the main phase to incorporate the T₁ phase. It is assumed that when the Nd—Fe phase in the grain boundary phase is converted to the T₁ phase, the proportion of the Nd phase in the grain boundary phase increases, which results in the improvement of coercive force and the enhancement of residual magnetic flux density because of the increase in the proportion of the T₁ phase.

### Examples

Hereinafter, embodiments of the present disclosure will be specifically described based on the Examples. However, the present disclosure is not limited to the Examples below.

1. Alloy Composition

Alloys having element compositions 1 to 22 listed in Table 1 were prepared.

TABLE 1

| | Elemental proportion (wt %) | | | | | | | | |
|---|---|---|---|---|---|---|---|---|---|
| No | Nd | Pr | Fe | B | Ga | Cu | Co | Al | Si |
| 1 | 28.5 | 0.0 | 69.78 | 1.02 | 0.40 | 0.1 | 0 | 0.1 | 0.1 |
| 2 | 29.0 | 0.0 | 69.32 | 0.98 | 0.40 | 0.1 | 0 | 0.1 | 0.1 |
| 3 | 29.0 | 0.0 | 69.24 | 1.06 | 0.40 | 0.1 | 0 | 0.1 | 0.1 |
| 4 | 28.3 | 0.0 | 70.05 | 0.95 | 0.40 | 0.1 | 0 | 0.1 | 0.1 |
| 5 | 29.5 | 0.0 | 68.85 | 0.95 | 0.40 | 0.1 | 0 | 0.1 | 0.1 |
| 6 | 29.5 | 0.0 | 68.80 | 1.00 | 0.40 | 0.1 | 0 | 0.1 | 0.1 |
| 7 | 29.7 | 0.0 | 68.70 | 0.90 | 0.40 | 0.1 | 0 | 0.1 | 0.1 |
| 8 | 29.5 | 0.0 | 68.75 | 1.05 | 0.40 | 0.1 | 0 | 0.1 | 0.1 |
| 9 | 29.1 | 0.4 | 68.9 | 0.9 | 0.40 | 0.1 | 0 | 0.08 | 0.08 |
| 10 | 29.1 | 0.4 | 68.8 | 0.9 | 0.55 | 0.1 | 0 | 0.08 | 0.08 |
| 11 | 29.1 | 0.4 | 68.6 | 0.9 | 0.70 | 0.1 | 0 | 0.08 | 0.08 |
| 12 | 29.1 | 0.4 | 68.9 | 0.95 | 0.40 | 0.1 | 0 | 0.08 | 0.08 |
| 13 | 29.1 | 0.4 | 68.7 | 0.95 | 0.55 | 0.1 | 0 | 0.08 | 0.08 |
| 14 | 29.1 | 0.4 | 68.6 | 0.95 | 0.70 | 0.1 | 0 | 0.08 | 0.08 |
| 15 | 29.1 | 0.4 | 68.8 | 1 | 0.40 | 0.1 | 0 | 0.08 | 0.08 |
| 16 | 29.1 | 0.4 | 68.7 | 1 | 0.55 | 0.1 | 0 | 0.08 | 0.08 |
| 17 | 29.1 | 0.4 | 68.5 | 1 | 0.70 | 0.1 | 0 | 0.08 | 0.08 |
| 18 | 28.1 | 0.4 | 69.9 | 0.9 | 0.40 | 0.1 | 0 | 0.08 | 0.08 |
| 19 | 28.1 | 0.4 | 69.9 | 0.95 | 0.40 | 0.1 | 0 | 0.08 | 0.08 |
| 20 | 28.1 | 0.4 | 69.8 | 1 | 0.40 | 0.1 | 0 | 0.08 | 0.08 |
| 21 | 29 | 0.4 | 69.0 | 0.94 | 0.39 | 0.12 | 0 | 0.08 | 0.08 |
| 22 | 28.3 | 0.0 | 70.09 | 0.94 | 0.39 | 0.12 | 0 | 0.08 | 0.08 |

2. Preparation of NdFeB Nanocrystal Ribbons

NdFeB nanocrystal ribbons were prepared in amounts of 180 g per lot using starting materials of the compositions in Table 1 by a liquid quenching method based on the Cu single roll method under the conditions in Table 2.

TABLE 2

| Melt temperature | 1430° C. | |
|---|---|---|
| Rolling velocity | 21.5 | m/sec |
| Nozzle diameter | 0.8 | mm |

| | |
|---|---|
| Atmosphere | Argon (Ar) |

3. Sintering

The NdFeB nanocrystal ribbons obtained above were coarsely pulverized and the coarse pulverized products were solidified under the solidification conditions in Table 3, followed by sintering. Thus, sintered bodies were obtained.

TABLE 3

| Temperature | 700° C. | |
|---|---|---|
| Pressure | 200 | MPa |
| Time | 3 | minutes |

| | |
|---|---|
| Atmosphere | Ar |

4. Hot Deformation Processing

Orientation control was performed on the sintered bodies obtained above by hot deformation processing under the following conditions. Thus, sintered bodies subjected to hot deformation processing were prepared as magnet precursors.

TABLE 4

| | |
|---|---|
| Processing temperature | 780° C. |
| Rate of work | 60-70% |
| Rate of distortion | 0.01-1/sec |

5. Heat Treatment (Aging)

The magnet precursors obtained above were subjected to two-stage heat treatment (aging) described in Table 5, thereby forming Nd—Fe—B magnets.

TABLE 5

| Heat treatment | 1st stage | 2nd stage |
|---|---|---|
| Temperature | 625° C. | 675° C. |
| Time | 30 minutes | 30 minutes |
| Atmosphere | Vacuum | Vacuum |
| Temperature | 20° C./min | 20° C./min |
| rising rate | | |
| Cooling rate | 40° C./min | 40° C./min |

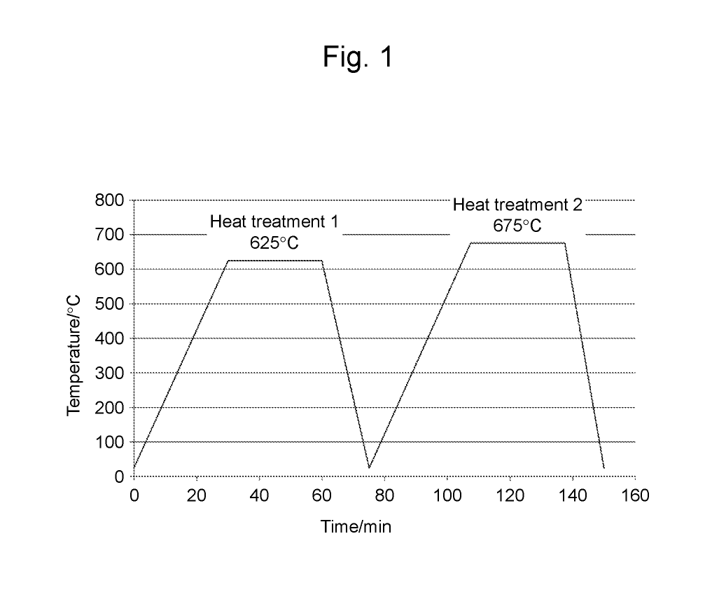

FIG. 1 is a diagram of the heating path (programmed values).

6. Evaluation of Magnetic Properties of Nd—Fe—B Magnets

After the end of the first stage of heat treatment and after the end of the second stage of heat treatment, each Nd—Fe—B magnet sample was processed into a shape of 4 mm×4 mm×2 mm (easy direction of magnetization) and magnetized with 8T, and then, the residual magnetic flux density (Br) was measured by a vibrating sample magnetometer (VSM).

Table 6 shows the results.

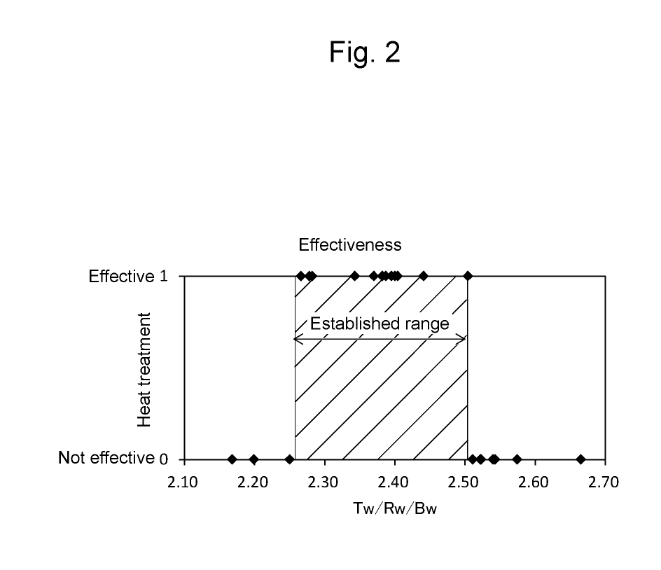

FIG. 2 is a diagram of the relationship between the composition ratio (Tw/Rw/Bw) and the presence or absence of the residual magnetic flux density increasing effect.

TABLE 6

| | | | | | | | | | | | | | | Residual | Residual | |
|---|---|---|---|---|---|---|---|---|---|---|---|---|---|---|---|---|
| | | | | | | | | | | | | | | magnetic | magnetic | |
| | | | | | | | | | | | | | | flux density | flux density | |
| | | | | | | | | | | | | | | after the 1st | after the 2nd | |
| | | | | | | | | | | Total composition | | | Composition | stage of heat | stage of heat | |
| | Elemental proportion (wt %) | | | | | | | | | proportion (wt %) | | | ratio | treatment | treatment | |
| No | Nd | Pr | Fe | B | Ga | Cu | Co | Al | Si | R | T | B | Tw/Rw/Bw | Br(T) | Br(T) | Effectiveness* |
| 1 | 28.5 | 0.0 | 69.78 | 1.02 | 0.40 | 0.1 | 0 | 0.1 | 0.1 | 29.2 | 69.78 | 1.02 | 2.343 | 1.421 | 1.434 | 1 |
| 2 | 29.0 | 0.0 | 69.32 | 0.98 | 0.40 | 0.1 | 0 | 0.1 | 0.1 | 29.7 | 69.32 | 0.98 | 2.382 | 1.432 | 1.449 | 1 |
| 3 | 29.0 | 0.0 | 69.24 | 1.06 | 0.40 | 0.1 | 0 | 0.1 | 0.1 | 29.7 | 69.24 | 1.06 | 2.199 | 1.434 | 1.437 | 0 |
| 4 | 28.3 | 0.0 | 70.05 | 0.95 | 0.40 | 0.1 | 0 | 0.1 | 0.1 | 29.0 | 70.05 | 0.95 | 2.543 | 1.396 | 1.391 | 0 |
| 5 | 29.5 | 0.0 | 68.85 | 0.95 | 0.40 | 0.1 | 0 | 0.1 | 0.1 | 30.2 | 68.85 | 0.95 | 2.400 | 1.374 | 1.390 | 1 |
| 6 | 29.5 | 0.0 | 68.80 | 1.00 | 0.40 | 0.1 | 0 | 0.1 | 0.1 | 30.2 | 68.8 | 1.00 | 2.278 | 1.420 | 1.435 | 1 |
| 7 | 29.7 | 0.0 | 68.70 | 0.90 | 0.40 | 0.1 | 0 | 0.1 | 0.1 | 30.4 | 68.7 | 0.90 | 2.511 | 1.363 | 1.362 | 0 |
| 8 | 29.5 | 0.0 | 68.75 | 1.05 | 0.40 | 0.1 | 0 | 0.1 | 0.1 | 30.2 | 68.75 | 1.05 | 2.168 | 1.369 | 1.371 | 0 |
| 9 | 29.1 | 0.4 | 68.9 | 0.9 | 0.40 | 0.1 | 0 | 0.08 | 0.08 | 30.2 | 68.9 | 0.90 | 2.540 | 1.336 | 1.341 | 0 |
| 10 | 29.1 | 0.4 | 68.8 | 0.9 | 0.55 | 0.1 | 0 | 0.08 | 0.08 | 30.3 | 68.79 | 0.90 | 2.522 | 1.353 | 1.358 | 0 |
| 11 | 29.1 | 0.4 | 68.6 | 0.9 | 0.70 | 0.1 | 0 | 0.08 | 0.08 | 30.5 | 68.64 | 0.90 | 2.504 | 1.385 | 1.396 | 1 |
| 12 | 29.1 | 0.4 | 68.9 | 0.95 | 0.40 | 0.1 | 0 | 0.08 | 0.08 | 30.2 | 68.89 | 0.95 | 2.404 | 1.365 | 1.384 | 1 |
| 13 | 29.1 | 0.4 | 68.7 | 0.95 | 0.55 | 0.1 | 0 | 0.08 | 0.08 | 30.3 | 68.74 | 0.95 | 2.387 | 1.373 | 1.386 | 1 |
| 14 | 29.1 | 0.4 | 68.6 | 0.95 | 0.70 | 0.1 | 0 | 0.08 | 0.08 | 30.5 | 68.59 | 0.95 | 2.370 | 1.361 | 1.375 | 1 |
| 15 | 29.1 | 0.4 | 68.8 | 1 | 0.40 | 0.1 | 0 | 0.08 | 0.08 | 30.2 | 68.8 | 1.00 | 2.282 | 1.378 | 1.391 | 1 |
| 16 | 29.1 | 0.4 | 68.7 | 1 | 0.55 | 0.1 | 0 | 0.08 | 0.08 | 30.3 | 68.69 | 1.00 | 2.266 | 1.342 | 1.397 | 1 |
| 17 | 29.1 | 0.4 | 68.5 | 1 | 0.70 | 0.1 | 0 | 0.08 | 0.08 | 30.5 | 68.54 | 1.00 | 2.250 | 1.363 | 1.368 | 0 |
| 18 | 28.1 | 0.4 | 69.9 | 0.9 | 0.40 | 0.1 | 0 | 0.08 | 0.08 | 29.2 | 69.94 | 0.90 | 2.665 | 1.433 | 1.431 | 0 |
| 19 | 28.1 | 0.4 | 69.9 | 0.95 | 0.40 | 0.1 | 0 | 0.08 | 0.08 | 29.2 | 69.89 | 0.95 | 2.523 | 1.437 | 1.442 | 0 |
| 20 | 28.1 | 0.4 | 69.8 | 1 | 0.40 | 0.1 | 0 | 0.08 | 0.08 | 29.2 | 69.84 | 1.00 | 2.395 | 1.368 | 1.380 | 1 |
| 21 | 29 | 0.4 | 69.0 | 0.94 | 0.39 | 0.12 | 0 | 0.08 | 0.08 | 30.1 | 68.99 | 0.94 | 2.441 | 1.370 | 1.382 | 1 |
| 22 | 28.3 | 0.0 | 70.09 | 0.94 | 0.39 | 0.12 | 0 | 0.08 | 0.08 | 29.0 | 70.09 | 0.94 | 2.574 | 1.420 | 1.420 | 0 |

*Effectiveness: In a case in which the residual magnetic flux density (Br) after the end of the 2nd stage of heat treatment (675° C.) increased by 0.01 T or more as compared with Br after the end of the 1st stage of heat treatment (625° C.), the effect was rated as “1” (effective). In other cases, the effect was rated as “0” (not effective)

What is claimed is:

1. A method of producing an Nd—Fe—B magnet, comprising:
producing a sintered body having a structure comprising a main phase and a grain boundary phase and having an Nd—Fe—B magnet composition in which Tw/(Rw×Bw) is 2.26 to 2.50,
wherein Rw represents a total percent (%) by weight of rare-earth elements and elements other than Fe, Ni, Co, B, N, and C,
Tw represents a total percent (%) by weight of Fe, Ni, and Co, and
Bw represents a total percent (%) by weight of B, N, and C; and
heat treating the sintered body in a low temperature range of 580° C. to 640° C. and a high temperature range of 660° C. or more.

2. The method according to claim 1, further comprising subjecting the sintered body to hot deformation processing after the production of the sintered body and before the heat treatment.
